(19) United States
(12) Patent Application Publication
(10) Pub. No.: US 2008/0297546 A1
(43) Pub. Date: Dec. 4, 2008

(54) INK JET IMAGE FORMING APPARATUS

(75) Inventors: Jae Yun LEE, Seoul (KR); Jin Ho Park, Yongin-si (KR); Sung Wook Kang, Seoul (KR); Young Su Lee, Yongin-si (KR); In Su Lee, Suwon-si (KR); Il Ju Mun, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/056,440

(22) Filed: Mar. 27, 2008

(30) Foreign Application Priority Data
May 28, 2007 (KR) 2007-51376

(51) Int. Cl. B41J 2/175; B41J 2/18; B41J 29/38

(52) U.S. Cl. 347/6; 347/85; 347/89

(57) ABSTRACT

An ink jet image forming apparatus, which is improved in a structure of an ink supply device so as to minimize an influence due to a pressure loss generated in an ink flow passage, is provided. The ink jet image forming apparatus includes a print head to eject an ink to a printing medium, an ink tank to store the ink, an ink circulation passage through which the ink circulates between the ink tank and the print head, a pressure controller which has an ink storage unit communicating with the ink circulation passage and an air storage unit communicating with external air, a valve mounted in the ink circulation passage between the ink tank and the pressure controller, a pump mounted in the ink circulation passage and pumps the ink, and a control unit to control operations of the valve and the pump.

### CROSS-REFERENCE TO RELATED APPLICATIONS

This application claims priority under 35 U.S.C. §119(a) from Korean Patent Application No. 2007-0051376, filed on May 28, 2007 in the Korean Intellectual Property Office, the disclosure of which is incorporated herein in its entirety by reference.

### BACKGROUND OF THE INVENTION

1. Field of the Invention

The present general inventive concept relates to an ink jet image forming apparatus, and more particularly to an ink jet image forming apparatus which is improved in a structure of an ink supply device so as to stably eject an ink from a print head.

2. Description of the Related Art

An ink jet image forming apparatus is an apparatus that forms an image by ejecting an ink to a printing medium. The ink jet image forming apparatus commonly includes an ink supply device to supply an ink stored in an ink tank to an ink channel in a print head. The ink supplied to the print head is ejected to a printing medium by the print head to print an image. At this time, if the ink stored in the ink tank contains a gas component dissolved therein, or if bubbles are generated in the ink while passing through the ink supply device, the ink is not ejected stably, and this causes deterioration of an image quality.

In order to solve this problem, Korean Patent Registration No. 708195 relates to a method of removing bubbles from the print head by forming an ink circulation passage between the print head and the ink tank and performing a circulation process and a purging process by operating a pump whenever necessary. Here, the circulation process is a process of periodically circulating the ink by the pump to collect the bubbles from the print head into the ink tank, and separating the bubbles from the ink tank. The purging process is a process of operating the pump while closing a valve mounted in the ink circulation passage to apply a large pressure to the print head, thereby exhausting the bubbles to the outside with a small amount of ink.

In order to stably eject the ink from the print head, besides removing the bubbles from the print head through the ink circulation and purging processes, minimizing an influence due to a pressure loss generated in the ink circulation passage when the ink is supplied to the print head through the ink circulation passage is also important. If the ink is ejected from the print head to print an image on the printing medium, a pressure in the print head drops corresponding to a consumed volume of the ink, and accordingly the ink is supplied to the print head through the ink circulation passage. When the ink is supplied to the print head, a pressure loss is generated due to a flow friction or components (e.g., a filter) mounted in the ink circulation passage. Such a pressure loss is transferred to the print head through the ink filled in the ink circulation passage, and acts as a resistance to the ink ejection.

### SUMMARY OF THE INVENTION

The present general inventive concept to provide an ink jet image forming apparatus which is improved in a structure of an ink supply device so as to minimize an influence due to a pressure loss generated in an ink flow passage.

Additional aspects and/or advantages of the present general inventive concept will be set forth in part in the description which follows and, in part, will be obvious from the description, or may be learned by practice of the present general inventive concept.

The foregoing and/or other aspects and utilities of the general inventive concept may be achieved by providing an ink jet image forming apparatus including a print head, an ink tank to store ink, an ink circulation passage through which the ink circulates between the ink tank and the print head, a pressure controller having an ink storage unit communicating with the ink circulation passage, and an air storage unit to communicate with external air, a valve mounted in the ink circulation passage between the ink tank and the pressure controller, a pump mounted in the ink circulation passage, and a control unit to control operations of the valve and the pump.

The air storage unit may include an air bag of which a volume is changed according to a pressure change of the ink storage unit.

The pressure controller may include a press member to press the air bag, and an elastic member to elastically support the press member.

The pressure controller may further include a sensor to detect a position of the press member.

The pump may perform bidirectional pumping.

When a printing operation is performed, the control unit closes the valve to interrupt the ink supply to the ink storage unit.

The control unit may perform a first pressure controller charging mode in which the control unit closes the valve and may operate the pump to expand the air bag.

The control unit may perform a second pressure controller charging mode in which the control unit stops the operation of the pump after the first pressure controller charging mode and opens the valve to charge the ink in the ink storage unit.

The control unit may perform a third pressure controller charging mode in which the control unit closes the valve after a predetermined period of time to maintain a negative pressure in the ink storage unit.

The foregoing and/or other aspects and utilities of the general inventive concept may also be achieved by providing an ink jet image forming apparatus including a print head having nozzles to eject an ink to a printing medium, and a channel unit to guide the ink supplied to the nozzles, an ink tank to store the ink, an ink supply passage to connect the ink tank and one side of the channel unit, an ink return passage to connect an other side of the channel unit and the ink tank, a pressure controller having an ink storage unit disposed in the ink supply passage, and an air bag communicating with external air to expand and contract, a valve mounted in the ink supply passage between the ink tank and the ink storage unit, a pump mounted in the ink return passage, and a control unit to control operations of the valve and the pump.

When a printing operation is performed, the control unit closes the valve to interrupt the ink supply to the ink storage unit through the ink supply passage.

The control unit may perform a first pressure controller charging mode in which the control unit closes the valve and operates the pump to expand the air bag.

The control unit may perform a second pressure controller charging mode in which the control unit stops an operation of the pump after the first pressure controller charging mode and opens the valve to supply the ink to the ink storage unit through the ink supply passage.

The control unit may perform a third pressure controller charging mode in which the control unit closes the valve after a predetermined period of time to maintain a negative pressure in the ink storage unit.

The control unit may perform a circulation mode in which the control unit opens the valve and controls the pump to circulate the ink in a first direction.

The pump may perform bidirectional pumping, and the control unit performs a purging mode in which the control unit closes the valve and controls the pump to pump the ink in a second direction so that the air bag contracts and the ink is ejected through the nozzles.

The foregoing and/or other aspects and utilities of the present general inventive concept may also be achieved by providing an ink jet image forming apparatus including a print head having nozzles to eject ink onto a printing medium, an ink tank to store the ink, an ink storage unit to receive the ink from the ink tank and to supply the ink to the print head and an air storage unit to expand and contract corresponding to a change in pressure of the ink storage unit.

The foregoing and/or other aspects and utilities of the present general inventive concept may also be achieved by providing an ink jet image forming apparatus having a plurality of modes, the apparatus including a print head, an ink tank to store ink, an ink circulation passage to circulate the ink between the ink tank and the print head, a pressure controller having an ink storage unit to communicate with the ink circulation passage and an air bag to communicate with air, a valve having a plurality of states, and disposed in the ink circulation passage between the ink tank and the pressure controller, a pump having a plurality of states, and disposed in the ink circulation passage, wherein one of the plurality of modes is selected based on the respective state of each of the valve and the pump.

The foregoing and/or other aspects and utilities of the present general inventive concept may also be achieved by providing an ink jet printing method including ejecting ink through nozzles of a print head to print an image on a printing medium, increasing negative pressure in the print head, supplying the ink from an ink storage unit of a pressure controller to the print head, and compensating for a pressure change in the ink storage unit by air flowing into an air bag of the pressure controller.

The foregoing and/or other aspects and utilities of the present general inventive concept may also be achieved by providing a computer-readable recording medium having embodied thereon a computer program to execute a method, wherein the method includes ejecting ink through nozzles of a print head to print an image on a printing medium, increasing negative pressure in the print head, supplying the ink from an ink storage unit of a pressure controller to the print head, and compensating for a pressure change in the ink storage unit by air flowing into an air bag of the pressure controller.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, of which:

FIG. 1 is a view conceptually illustrating a constitution of an ink jet image forming apparatus in accordance with an embodiment of the present general inventive concept;

FIG. 2 is a view illustrating a nozzle unit of a print head in the ink jet image forming apparatus depicted in FIG. 1;

FIG. 3 is a view illustrating a constitution of an ink supply device in the ink jet image forming apparatus in accordance with an embodiment of the present general inventive concept;

FIGS. 4 to 9 are views illustrating an operation of the ink jet image forming apparatus in accordance with an embodiment of the present general inventive concept; and

FIG. 10 is a flowchart illustrating an ink jet method according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to like elements throughout. The embodiments are described below in order to explain the present general inventive concept by referring to the figures.

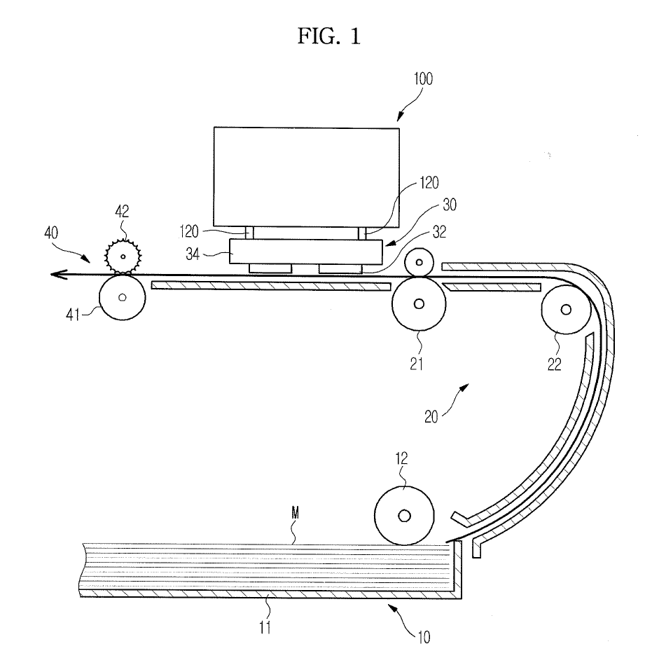

FIG. 1 is a view conceptually illustrating a constitution of an ink jet image forming apparatus in accordance with an embodiment of the present general inventive concept.

As illustrated in FIG. 1, the ink jet image forming apparatus according to an embodiment of the present general inventive concept includes a paper supply unit 10 to supply a printing medium M, a feeding unit 20 to feed the printing medium, a print head 30 to form an image on the printing medium fed by the feeding unit 20, an ink supply device 100 to supply an ink to the print head 30, and a discharge unit 40 to discharge the printing medium, on which an image has been printed, to the outside of the image forming apparatus.

The paper supply unit 10 includes a paper supply tray 11 on which the printing medium M is loaded, and a pick up roller 12 to pick up the printing medium loaded on the paper supply tray 11 sheet by sheet. The feeding unit 20 feeds the printing medium picked up by the pickup roller 12 to an area below the print head 30, and includes a feeding roller 21 which is mounted near an inlet of the print head 30, and an auxiliary roller 22 which is mounted between the feeding roller 21 and the pickup roller 12.

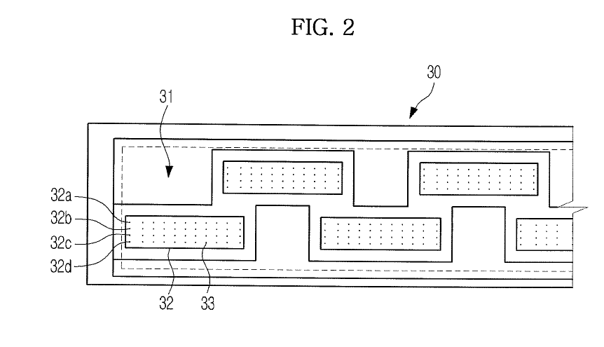

In this embodiment, the print head 30 is configured as an array print head which is provided with a nozzle unit 31 (FIG. 2) having a length corresponding to a width of the printing medium. Such a print head 30 prints an image by ejecting the ink to the printing medium M at the fixed position. FIG. 2 is a view illustrating the nozzle unit 31 of the print head in the ink jet image forming apparatus depicted in FIG. 1. As illustrated in FIG. 2, a nozzle unit 31 is provided with a plurality of head chips 32 which are arranged in a zigzag shape in a width direction of the nozzle unit 31. Each of the head chips 32 is formed with a plurality of nozzles 33 through which the ink is ejected. Each head chip 32 may be provided with a plurality of nozzle rows 32a, 32b, 32c and 32d. The respective nozzle rows 32a, 32b, 32c and 32d can eject the ink of a same color or different colors (e.g., cyan, magenta, yellow and black). When the print head 30 is constituted to eject the ink of different colors, the ink supply device 100 (FIG. 1) is provided to supply each color.

Referring to FIGS. 1 and 2, the print head 30 further includes a channel unit 34 to guide the ink supplied from the ink supply device 100. The channel unit 34 is formed with an ink channel (not illustrated) thereinside, so that the ink can be evenly supplied to the nozzles 33 of the print head 30.

The discharge unit 40 includes a discharge roller 41 which is mounted in a downstream side of the print head 30 with respect to a feeding direction of the printing medium M, and a star wheel 42 which is mounted opposite to the discharge roller 41. The star wheel 42 functions to prevent the printing medium M passing below the nozzle unit 31 from contacting the nozzle unit 31, or prevent a gap between the printing medium M and the nozzle unit 31 from being changed.

The ink supply device 100 is connected to the channel unit 34 of the print head 30 by the ink circulation passage 120 through which the ink circulates. The ink supply device 100 is conceptually illustrated in FIG. 1, however the ink supply device 100 may be integrally formed in a cartridge shape with the print head 30, or may be mounted in a set separately from the print head 30.

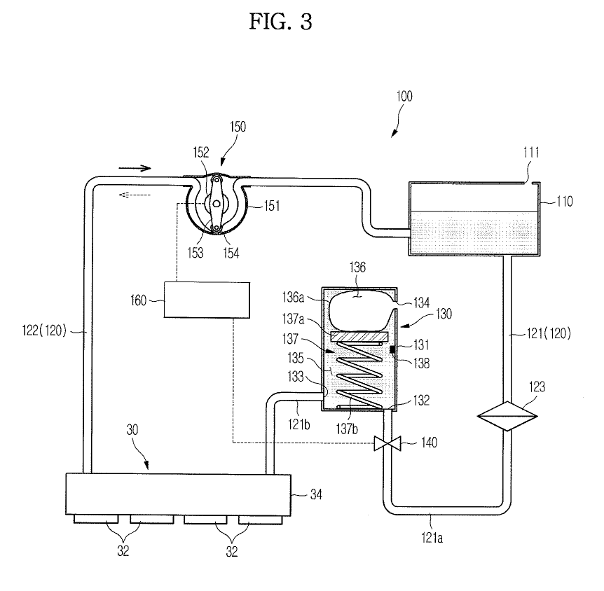

FIG. 3 is a view illustrating the constitution of the ink supply device in the ink jet image forming apparatus in accordance with an embodiment of the present general inventive concept.

As illustrated in FIG. 3, the ink supply device 100 includes an ink tank 110 to store the ink, an ink circulation passage 120 which has an ink supply passage 121 connecting the ink tank 110 and one side of the channel unit 34 and an ink return passage 122 connecting an other side of the channel unit 34 and the ink tank 110, a pressure controller 130 which is mounted in the ink supply passage 121, a valve 140 to open and close the ink supply passage 121, a pump 150 to circulate the ink by force, and a control unit 160 to control an operation of the valve 140 and the pump 150.

The ink stored in the ink tank 110 is supplied to the print head 30 through the ink supply passage 121, and the ink collected from the print head 30 is stored in the ink tank 110 via the ink return passage 122. The ink tank 110 has an atmosphere communication hole 111 through which the ink tank 110 communicates with the atmosphere. When the ink is collected from the print head 30, bubbles in the print head 30 are also collected into the ink tank 110, and are exhausted to the outside through the atmosphere communication hole 111.

An ink filter 123 is mounted in the ink supply passage 121 between the ink tank 110 and the valve 140. The ink filter 123 removes foreign substances from the ink which is supplied from the ink tank 110 to the print head 30.

The pressure controller 130 applies a negative pressure within a predetermined range to the print head 30 so that the ink does not leak from the print head 30, and supplies the ink to the print head 30 while the ink supply through the ink supply passage 121 is interrupted by the valve 140 in the printing operation.

Referring to FIG. 3, the pressure controller 130 has a housing 131 which is formed with an ink inlet hole 132, an ink outlet hole 133 and an airflow hole 134. Inside the housing 131 are provided an ink storage unit 135 which is a space communicating with the ink inlet hole 132 and the ink outlet hole 133, and an air storage unit 136 which is a space communicating with the airflow hole 134. When the ink supply passage 121 is sectioned into a first supply passage 121a and a second supply passage 121b from the pressure controller 130, the ink inlet hole 132 is connected with the first supply passage 121a, and the ink outlet hole 133 is connected with the second supply passage 121b.

The air storage unit 136 communicates with the external air through the air flow hole 134, and the volume of the air storage unit 136 is changed according to the change of the pressure in the ink storage unit 135. The air storage unit 136 may be defined by an air bag 136a which is made of a flexible material capable of expanding and contracting and is mounted inside the housing 131. If the ink is exhausted from the ink storage unit 135 and the pressure in the ink storage unit 135 drops, the air flows into the air bag 136a to compensate for the pressure change in the ink storage unit 135. For example, if the printing operation is performed while the valve 140 is closed and the ink in the ink storage unit 135 is supplied to the print head 30, the pressure in the ink storage unit 135 drops. At this time, the air bag 136a expands by the air flowing into the air bag 136a, thereby compensating for the pressure change.

The housing 131 is provided with a press unit 137 thereinside, to press the air bag 136a. The press unit 137 presses the air bag 136a, in which the air is filled, so that the air cannot flow successively into the air bag 136a and the interior of the ink storage unit 135 can keep the negative pressure within a predetermined range. The press unit 137 includes a press member 137a which is in contact with the air bag 136a and presses the air bag 136a, and an elastic member 137b to elastically support the press member 137a.

The pressure controller 130 may further include a sensor 138 to detect the position of the press member 137a. By the sensor 138 detecting the position of the press member 137a, how much ink remains in the ink storage unit 135 can be indirectly estimated. If the amount of ink in the ink storage unit 135 decreases as the ink is supplied from the ink storage unit 135 to the print head 30, the air bag 136a expands, and the press member 137a moves. At this time, by the sensor 138 detecting the moving position of the press member 137a, the amount of ink remaining in the ink storage unit 135 can be estimated.

The valve 140 is mounted in the ink supply passage 121 between the ink tank 110 and the pressure controller 130, i.e., the valve 140 is mounted in the first supply passage 121a. If the valve 140 is closed by the control unit 160, the ink in the pressure controller 130, the second supply passage 121b and the print head 30 is isolated from the ink in the ink tank 110 and the first supply passage 121a between the valve 140 and the ink tank 110.

The pump 150 is mounted in the ink return passage 122, and can perform bidirectional pumping. The pump 150 includes a body 151 which has an inner peripheral surface of a circular arc shape, a pumping motor 152 to rotate in a forward/reverse direction, a roller arm 153 to rotate by the pumping motor 152, and rollers 154 which are mounted to both ends of the roller arm 153 to press the ink return passage 122. If the roller arm 153 rotates in a counterclockwise direction by the pumping motor 152, the ink is pumped in the arrow direction illustrated by a solid line in FIG. 3 (hereinafter, referred to as a first direction). Alternatively, if the roller arm 153 rotates in a clockwise direction by the pumping motor 152, the ink is pumped in the arrow direction illustrated by a dotted line in FIG. 3 (hereinafter, referred to as a second direction). Because an example of the pump as structured above is disclosed in Korean Patent Laid-Open Publication No. 2007-0049395 which is incorporated by reference in its entirety, a more detailed explanation will be omitted.

By controlling the pump 150 and the valve 140, the control unit 160 controls the overall operation of the image forming apparatus, such as an operation of circulating the ink through the ink circulation passage 120, an operation of charging the ink into the ink storage unit 135 of the pressure controller 130, and the like.

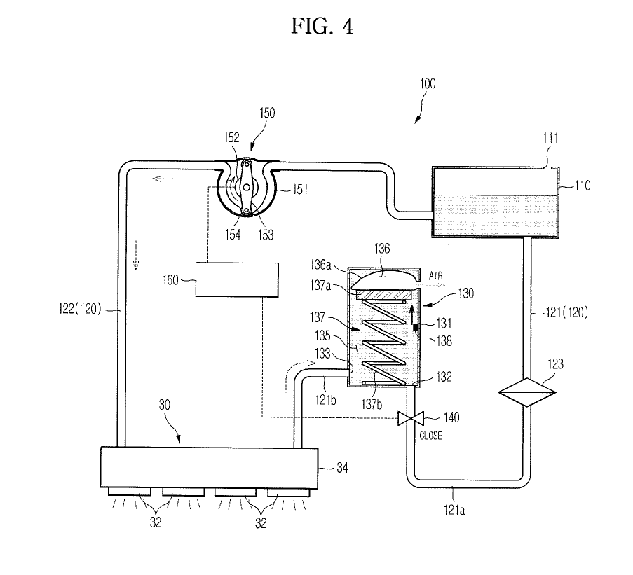

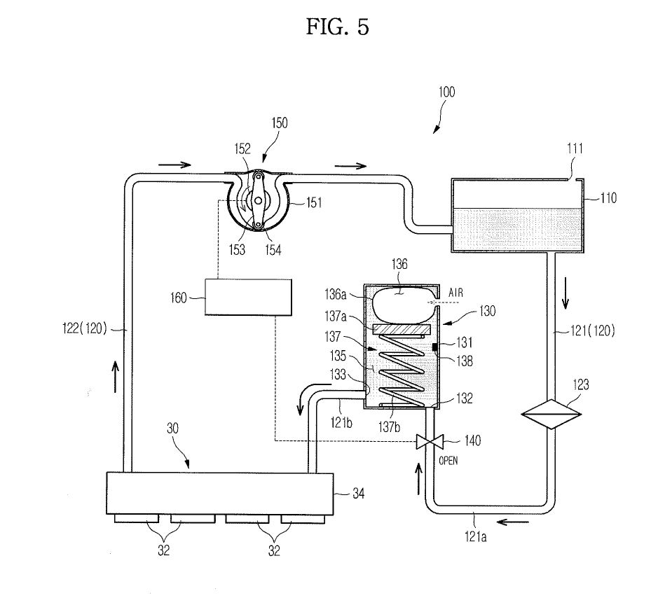

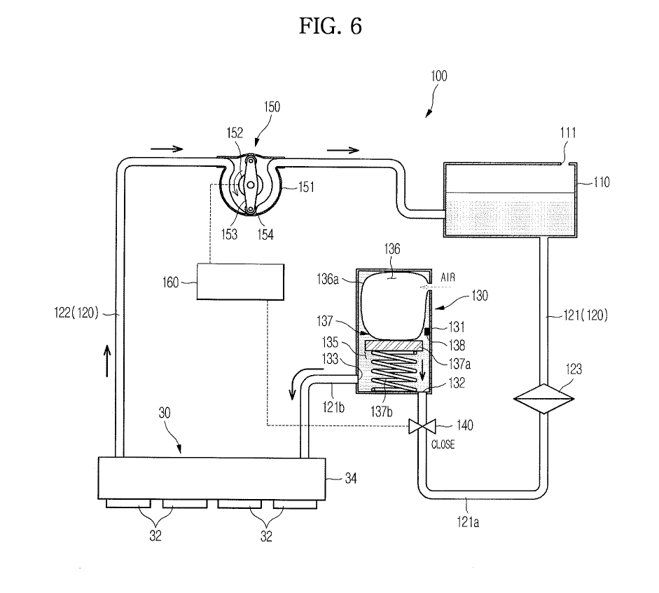

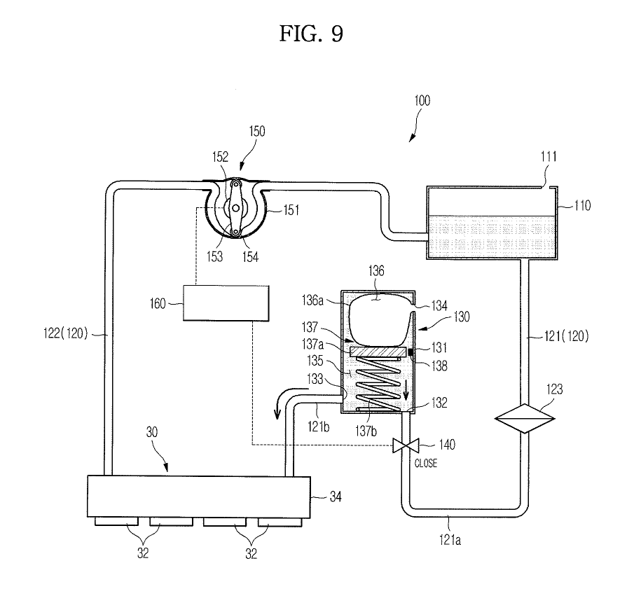

Hereinafter, the operation of the ink jet image forming apparatus according to an embodiment of the present general inventive concept will be described with reference to FIGS. 4 to 9. FIG. 4 is a view illustrating a purging mode, FIG. 5 is a view illustrating a circulation mode, FIGS. 6 to 8 are views illustrating a pressure controller charging mode, and FIG. 9 is a view illustrating a printing mode.

Referring to FIG. 4, the purging mode will be explained. In the purging mode, the control unit 160 controls the pumping motor 152 to rotate the roller arm 153 in the clockwise direction, and closes the valve 140. If the roller arm 153 rotates in the clockwise direction, the ink is pumped in the second direction (the arrow direction illustrated by the dotted line). At this time, because the valve 140 is in the closed state, a pressure is applied to the pressure controller 130 and the print head 30. The air bag 136a in the pressure controller 130 contracts by the pumping force. If the air bag 136a contracts to a maximum contractual state, the ink and the air are exhausted through the print head 30.

Referring to FIG. 5, the circulation mode will be explained. In the circulation mode, the control unit 160 controls the pumping motor 152 to rotate the roller arm 153 in the counterclockwise direction, and opens the valve 140. If the roller arm 153 rotates in the counterclockwise direction, the ink is pumped in the first direction (the arrow direction illustrated by the solid line). A negative pressure is generated in the print head 30 by the pumping force, so that the ink and the bubbles in the print head 30 are collected into the ink tank 110 through the ink return passage 122, and the ink stored in the ink tank 110 is supplied to the print head 30 through the ink supply passage 121. The bubbles contained in the ink collected from the print head 30 are separated in the ink tank 110, and are exhausted to the outside through the atmosphere communication hole 111.

Referring to FIGS. 6 to 8, the pressure controller charging mode will be explained. In the pressure controller charging mode, the ink is directed into the ink storage unit 135 of the pressure controller 130, and a negative pressure is generated in the pressure controller 130. When the image forming apparatus performs a printing operation, the ink stored in the ink storage unit 135 is supplied to the print head 30. The pressure controller charging mode can be classified as a first pressure controller charging mode to a third pressure controller charging mode.

In the first pressure controller charging mode as illustrated in FIG. 6, the control unit 160 controls the pump 150 to pump the ink in the first direction, and closes the valve 140. If the ink is pumped in the first direction with the valve 140 in the closed state, the pumping force is transmitted through the ink return passage 122, so that the ink stored in the ink storage unit 135 of the pressure controller 130 flows out through the ink outlet hole 133, and the negative pressure in the ink storage unit 135 increases greatly. The air bag 136a of the pressure controller 130 expands to a maximum expansion state.

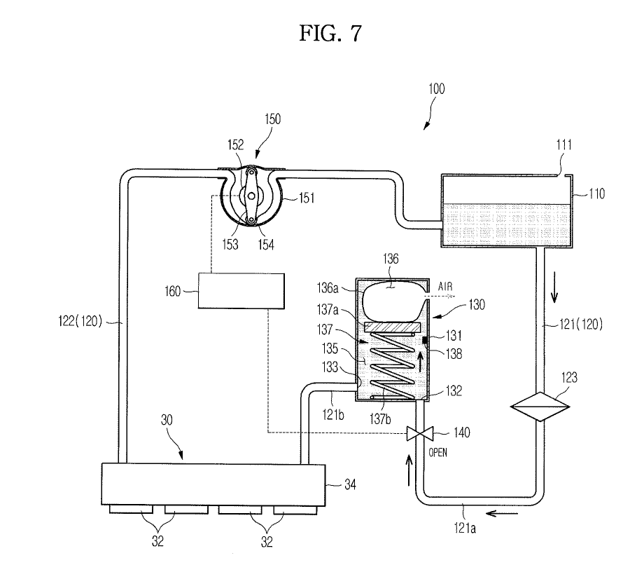

Thereafter, the control unit 160 stops an operation of the pump 150 as illustrated in FIG. 7, and opens the valve 140 for a predetermined period of time (the second pressure controller charging mode). At this time, while the operation is stopped, the pump 150 closes the ink passage by pressing the ink return passage 122. The pressure difference between the ink storage unit 135 and the ink tank 110 causes the ink in the ink tank 110 to be supplied to the ink storage unit 135. As the ink flows into the ink storage unit 135, the negative pressure in the ink storage unit 135 decreases, and accordingly the air bag 136a contracts.

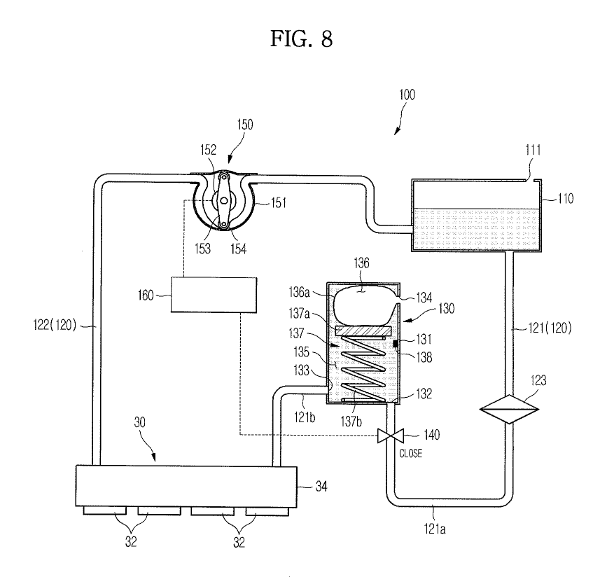

When the predetermined period of time elapses, the control unit 160 closes the valve 140 (the third pressure controller charging mode). As illustrated in FIG. 8, the ink is stopped being supplied to the ink storage unit 135, and the negative pressure is maintained adequately in the ink storage unit 135.

After the pressure controller 130 is charged with the ink as described above, the printing mode is performed. Referring to FIG. 9, the printing mode will be explained. In the printing mode, the control unit 160 keeps the pump 150 in the stopped state, and also keeps the valve 140 in the closed state. In this state, the print head 30 ejects the ink through the nozzles 33 (refer to FIG. 2) to print an image on the printing medium. If the ink is ejected from the print head 30, the negative pressure in the print head 30 increases, so that the ink in the ink storage unit 135 of the pressure controller 130 is supplied to the print head 30 through the second supply passage 121b. As the ink in the ink storage unit 135 is consumed, air flows into the air bag 136a of the pressure controller 130 to compensate for the pressure change in the ink storage unit 135. The printing mode is performed while the pressure controller 130 is isolated from the ink tank 110 and the first supply passage 121a by closing the valve 140. Accordingly, the pressure loss generated in the ink supply passage 121 has no influence on the print head 30. Accordingly, the ink ejection can be stably achieved in the printing operation.

As the printing operation is performed continuously, an amount of ink in the ink storage unit 135 decreases gradually, and the negative pressure in the ink storage unit 135 increases. At this time, the air bag 136a expands gradually to reduce a degree of increase of the negative pressure in the ink storage unit 135. However, the pressure controller 130 recharges at a proper point of time. The point of time of charging the pressure controller 130 can be known from the sensor 138 mounted in the pressure controller 130. That is, if the air bag 136a expands, the press member 137a moves in the direction of pressing the elastic member 137b. If the press member 137a is sensed by the sensor 138, the pressure controller charging mode is performed. At this time, bubbles in the print head 30 or in the ink circulation passage 120 can be removed by performing the aforesaid circulation mode before performing the pressure controller charging mode.

Besides the method of using the sensor as described above, the point of time of charging the pressure controller 130 can be determined by calculating the amount of ink ejected on the printing medium from the print head 30 (so-called dot count method).

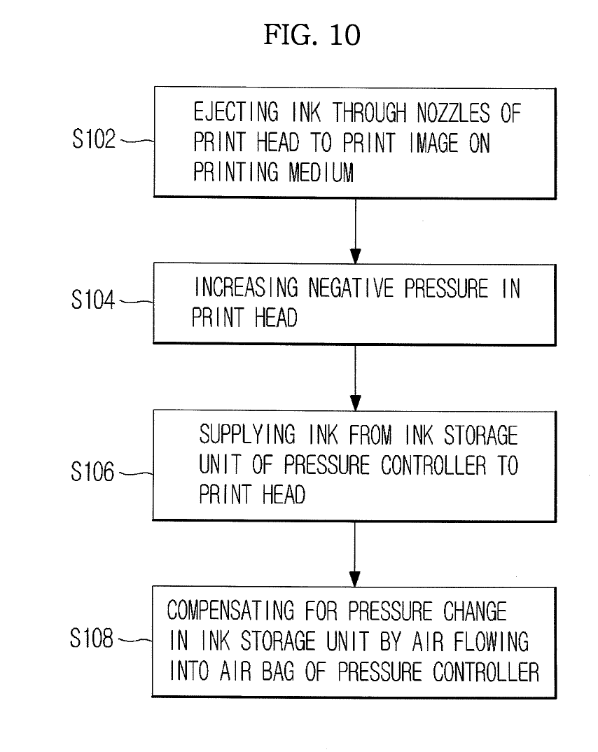

FIG. 10 is a flowchart illustrating an ink jet method according to an embodiment of the present general inventive concept. Referring to FIG. 10, in operation S102, ink is ejected through nozzles 33 of a print head 30 to print an image on a printing medium. In operation S104, negative pressure is increased in the print head 30. In S106, the ink is supplied from an ink storage unit 135 of a pressure controller 130 to the print head 30. In S108, a pressure change in the ink storage unit 135 is compensated for by air flowing into an air bag 136a of the pressure controller 130.

The operational states of the pump 150 and the valve 140 in the respective modes described above can be summarized as the following table 1.

TABLE 1

| Mode | Pump | Valve |
|---|---|---|
| Purging Mode | Pumping in the Second | Close |
| | Direction | |
| Circulation Mode | Pumping in the First Direction | Open |
| First Pressure | Pumping in the First Direction | Close |
| Controller Charging Mode | | |
| Second Pressure | OFF | Open |
| Controller Charging Mode | | |
| Third Pressure | OFF | Close |
| Controller Charging Mode | | |
| Printing Mode | OFF | Close |

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As apparent from the above description, an ink jet image forming apparatus according to various embodiments of the present general inventive concept performs a printing operation while a print head is isolated from an ink supply passage and receives ink from a pressure controller. Accordingly, influence by pressure loss generated in the ink passage is minimized. Accordingly, ink ejection from the print head can be stably achieved, thereby increasing image quality.

Although various embodiments of the present general inventive concept have been illustrated and described, it would be appreciated by those skilled in the art that changes may be made in these embodiments without departing from the principles and spirit of the present general inventive concept, the scope of which is defined in the claims and their equivalents.

What is claimed is:

1. An ink jet image forming apparatus, comprising:
a print head;
an ink tank to store ink;
an ink circulation passage through which the ink circulates between the ink tank and the print head;
a pressure controller having an ink storage unit to communicate with the ink circulation passage, and an air storage unit communicating with external air;
a valve mounted in the ink circulation passage between the ink tank and the pressure controller;
a pump mounted in the ink circulation passage; and
a control unit to control operations of the valve and the pump.

2. The ink jet image forming apparatus according to claim 1, wherein the air storage unit comprises:
an air bag of which a volume is changed according to a pressure change of the ink storage unit.

3. The ink jet image forming apparatus according to claim 2, wherein the pressure controller comprises:
a press member to press the air bag; and
an elastic member to elastically support the press member.

4. The ink jet image forming apparatus according to claim 3, wherein the pressure controller further comprises:
a sensor to detect a position of the press member.

5. The ink jet image forming apparatus according to claim 1, wherein the pump performs bidirectional pumping.

6. The ink jet image forming apparatus according to claim 1, wherein when a printing operation is performed, the control unit closes the valve to interrupt the ink supply to the ink storage unit.

7. The ink jet image forming apparatus according to claim 2, wherein the control unit comprises:
a first pressure controller charging mode in which the control unit closes the valve and operates the pump to expand the air bag.

8. The ink jet image forming apparatus according to claim 7, wherein the control unit further comprises:
a second pressure controller charging mode in which the control unit stops an operation of the pump after the first pressure controller charging mode and opens the valve to charge the ink in the ink storage unit.

9. The ink jet image forming apparatus according to claim 8, wherein the control unit further comprises:
a third pressure controller charging mode in which the control unit closes the valve after a predetermined period of time to maintain a negative pressure in the ink storage unit.

10. An ink jet image forming apparatus comprising:
a print head having nozzles to eject an ink to a printing medium, and a channel unit to guide the ink supplied to the nozzles;
an ink tank to store ink;
an ink supply passage to connect the ink tank and one side of the channel unit;
an ink return passage to connect an other side of the channel unit and the ink tank;
a pressure controller having an ink storage unit disposed in the ink supply passage, and an air bag communicating with external air to expand and contract;
a valve mounted in the ink supply passage between the ink tank and the ink storage unit;
a pump mounted in the ink return passage; and
a control unit to control operations of the valve and the pump.

11. The ink jet image forming apparatus according to claim 10, wherein when a printing operation is performed, the control unit closes the valve to interrupt the ink supply to the ink storage unit through the ink supply passage.

12. The ink jet image forming apparatus according to claim 10, wherein the control unit comprises:
a first pressure controller charging mode in which the control unit closes the valve and operates the pump to expand the air bag.

13. The ink jet image forming apparatus according to claim 12, wherein the control unit further comprises:
a second pressure controller charging mode in which the control unit stops an operation of the pump after the first pressure controller charging mode and opens the valve to supply the ink to the ink storage unit through the ink supply passage.

14. The ink jet image forming apparatus according to claim 13, wherein the control unit further comprises:
a third pressure controller charging mode in which the control unit closes the valve after a predetermined period of time to maintain a negative pressure in the ink storage unit.

15. The ink jet image forming apparatus according to claim 10, wherein the control unit comprises:
a circulation mode in which the control unit opens the valve and controls the pump to circulate the ink in a first direction.

16. The ink jet image forming apparatus according to claim 10, wherein the pump performs bidirectional pumping, and
the control unit includes a purging mode in which the control unit closes the valve and controls the pump to pump the ink in a second direction so that the air bag contracts and the ink is ejected through the nozzles.

17. An ink jet image forming apparatus, comprising:
a print head having nozzles to eject ink onto a printing medium;
an ink tank to store the ink;
an ink storage unit to receive the ink from the ink tank and to supply the ink to the print head; and
an air storage unit to expand and contract corresponding to a change in pressure of the ink storage unit.

18. An ink jet image forming apparatus having a plurality of modes, the apparatus comprising:
a print head;
an ink tank to store ink;
an ink circulation passage to circulate the ink between the ink tank and the print head;
a pressure controller having an ink storage unit to communicate with the ink circulation passage and an air bag to communicate with air;
a valve having a plurality of states, and disposed in the ink circulation passage between the ink tank and the pressure controller;
a pump having a plurality of states, and disposed in the ink circulation passage;
wherein one of the plurality of modes is selected based on the respective state of each of the valve and the pump.

19. The ink jet image forming apparatus of claim 18, wherein:
the plurality of states of the pump comprise:
an off state;
a pumping in a first direction state; and
a pumping in a second direction state; and
the plurality of states of the valve comprise:
an open state; and
a close state.

20. The ink jet image forming apparatus of claim 19, wherein one of the plurality of modes comprises:
a purging mode, selected by the valve being in the closed state and the pump being in the pumping in the second direction state, to apply pressure to the pressure controller and the print head.

21. The ink jet image forming apparatus of claim 19, wherein one of the plurality of modes comprises:
a circulation mode, selected by the valve being in the open state and the pump being in the pumping in the first direction state, to apply a negative pressure to the print head.

22. The ink jet image forming apparatus of claim 19, wherein one of the plurality of modes comprises:
a first pressure controller charging mode, selected by the valve being in the closed state and the pump being in the pumping in the first direction state, to increase negative pressure in the ink storage unit and to expand the air bag to a maximum expansion state.

23. The ink jet image forming apparatus of claim 19, wherein one of the plurality of modes comprises:
a second pressure controller charging mode, selected by the valve being in the open state and the pump being in the off state, to decrease negative pressure in the ink storage unit and to contract the air bag.

24. The ink jet image forming apparatus of claim 19, wherein one of the plurality of modes comprises:
a third pressure controller charging mode, selected by the valve being in the closed state and the pump being in the off state, to maintain negative pressure in the ink storage unit.

25. A computer-readable recording medium having embodied thereon a computer program to execute a method, wherein the method comprises:
ejecting ink through nozzles of a print head to print an image on a printing medium;
increasing negative pressure in the print head;
supplying the ink from an ink storage unit of a pressure controller to the print head; and
compensating for a pressure change in the ink storage unit by air flowing into an air bag of the pressure controller.
